(19) United States
(12) Patent Application Publication
(10) Pub. No.: US 2025/0143203 A1
(43) Pub. Date: May 8, 2025

(54) PLANNING PORTAL FOR PLANNING AGRICULTURAL USE

(71) Applicant: CLAAS KGaA mbH, Harsewinkel (DE)

(72) Inventors: Thijs Verploegen, Düsseldorf (DE); Stefan Peters, Münster (DE); Josef Fischer, Biberach (DE); Jan Carsten Wieckhorst, Uelzen Ortsteil Hanstedt (DE); Jannik Redenius, Oldendorf (DE); Axel Schröder, Gütersloh (DE); Felix Hülsmann, Bielefeld (DE); Robin Monkenbusch, Rheda-Wiedenbrück (DE)

(73) Assignee: CLAAS KGaA mbH, Harsewinkel (DE)

(21) Appl. No.: 18/941,407

(22) Filed: Nov. 8, 2024

(30) Foreign Application Priority Data
Nov. 8, 2023 (DE) 10 2023 130 887.4

(51) Int. Cl. A01B 79/00

(52) U.S. Cl. CPC A01B 79/005

(57) ABSTRACT

A planning portal for a farmer to planning and to initiate an agricultural operation of an autonomous agricultural work machine on an agricultural field. The planning portal is configured in such a way that, during planning, only the use is permitted of attachments which may have dimensions such that the attachments are arranged or positioned completely within the detectable surrounding area during the state in which the attachments are coupled to the autonomous agricultural work machine.

### CROSS REFERENCE TO RELATED APPLICATIONS

This application claims priority under 35 U.S.C. § 119 to German Patent Application No. DE 10 2023 130 887.4 filed Nov. 8, 2023, the entire disclosure of which is hereby incorporated by reference herein. This application is related to U.S. application Ser. No. ______ (attorney-docket number 15191-24024A (P05791/8), which is incorporated by reference herein in its entirety.

### TECHNICAL FIELD

The present invention relates to a planning portal for a farmer to plan and to initiate an agricultural operation of an autonomous agricultural work machine on an agricultural field. The autonomous agricultural work machine is configured to detect a surrounding area during the agricultural use via a sensor-based system.

### BACKGROUND

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

In modern agriculture, there are increasing efforts to perform agricultural jobs autonomously in order to increase the productivity and economy of the processes. So-called autonomous agricultural work machines are used for this purpose, which are characterized in that these autonomous agricultural work machines have a semi-autonomous operating mode and/or a fully autonomous operating mode. During the semi-autonomous operating mode, there is an operator in the cab of the agricultural work machine; however, this operator is not involved in the control and regulation process of the respective agricultural work machine. In this context, the autonomous agricultural work machine may switch between the semi-autonomous operating mode and normal operation (i.e., manual driving).

The fully autonomous operating mode is characterized in that no operator is assigned to the agricultural work machine. Accordingly, in fully autonomous operating mode, there is no operator available who knows the agricultural work process to be performed with a sequence of different work steps and who may execute or assign individual control functions during operation of the work machine in an agricultural field.

### BRIEF DESCRIPTION OF THE DRAWINGS

The present application is further described in the detailed description which follows, in reference to the noted drawings by way of non-limiting examples of exemplary embodiment, in which like reference numerals represent similar parts throughout the several views of the drawings, and wherein:

FIG. 1 illustrates a planning portal for a farmer for planning and initiating an agricultural operation of an autonomous agricultural work machine on an agricultural field.

### DETAILED DESCRIPTION

As discussed in the background, autonomous agricultural work machines may be used for various agricultural jobs. The planning of the agricultural use of the autonomous agricultural work machine(s) may comprise at least one planning step (in which attachment(s) is/are selected and which may be coupled to the autonomous agricultural work machine(s) during the agricultural use). The initiation of an agricultural use may be based on the planning, and may comprise one or more initiation signals that may be transmitted (such as at least partly automatically or entirely automatically transmitted) to the autonomous agricultural work machine(s). During the agricultural use, the autonomous agricultural work machine may use these one or more initiation signals in addition to other signals, such as sensor signals, to control and/or regulate the autonomous agricultural work machine and/or the attachment that is physically connected to the autonomous agricultural work machine.

In one or some embodiments, a planning portal for the farmer of the autonomous agricultural work machine is disclosed that improves or ensures the safe use of the autonomous agricultural work machine.

In one or some embodiments, the planning portal may have information, such as information saved in a computer-readable data memory, relating to the detectable surrounding area of the autonomous agricultural work machine and dimensional information relating to dimensions of the attachment so that only the use of attachments that have dimensions such that the attachment is arranged completely within the detectable surrounding area during the state coupled to the autonomous agricultural working machine is permitted during planning and thereafter at least partly (or entirely) automatic execution of the autonomous agricultural work machine.

This may ensure that no attachments are used with the autonomous agricultural work machine that would be arranged or positioned outside the detectable surrounding area (when the respective attachment is connected to the autonomous agricultural work machine) and may therefore be a problem, such as endanger people, during agricultural use.

The autonomous agricultural work machine may use a semi-autonomous operating mode and/or a fully autonomous operating mode during agricultural use. An autonomous agricultural work machine that has a semi-autonomous operation mode may include a driver's cab. An autonomous agricultural work machine that has a fully autonomous operating mode may be designed without a driver's cab. An autonomous agricultural work machine that has a semi-autonomous operating mode and a fully autonomous operating mode may have a detachably connectable driver's cab. In this regard, responsive to the planning (which may be at least partly or entirely automatically performed), the results of the planning may be at least partly (such as fully) automatically used by the autonomous agricultural work machine.

In one or some embodiments, the information relating to the detectable surrounding area of the autonomous agricultural work machine may depend on the design of the machine and/or properties of the sensor-based system. This may include a measured arrangement of the sensor-based system on the attachment. In one or some embodiments, the dimensional information relating to the dimensions of the attachment may be measured dimensional values.

In one or some embodiments, the planning portal has information relating to the detectable surrounding areas of a plurality of autonomous agricultural work machines and dimensional information relating to dimensions of a plurality of attachments. The plurality of autonomous agricultural working machines may form different work machines and/or have different configurations. In addition, the plurality of attachments may form different attachments and/or have different designs, such as different dimensions. This may allow the farmer to quickly and reliably link or correlate a large number of different autonomous agricultural work machines with the appropriate attachments in planning. In turn, this ability to link or correlate a large number of different autonomous agricultural work machines with the appropriate attachments in planning may enable a more flexible and/or more efficient way to both: (i) at least partly automatically plan; and/or (ii) at least partly automatic operation(s) (e.g., at least partly automatically execute the plan using the autonomous agricultural work machine(s) with the attachment(s)).

In one or some embodiments, the planning portal may be in communication with (e.g., wired and/or wireless communication) a means of communication with which the farmer may select in planning the attachment that will be coupled to the autonomous agricultural work machine during agricultural use. Various means of communication are contemplated. As example, the means of communication may be any one, any combination, or all of: a smartphone; a tablet; a laptop; or a computer.

In one or some embodiments, the information relating to the detectable surrounding area may refer to a surrounding area of the autonomous agricultural work machine, such as a transverse surrounding area of the autonomous agricultural work machine.

In one or some embodiments, the dimensional information may relate to transverse dimensions of the attachment. These transverse dimensions, such as the transverse width, may refer to the dimension of the attachment transverse to the direction of travel, such as transverse to the straight-ahead direction of travel, of the autonomous agricultural work machine.

In one or some embodiments, the information relating to the detectable surrounding area of the autonomous agricultural work machine may relate to a dimension transverse to the direction of travel, such as transverse to the of straight-ahead direction of travel, of the autonomous agricultural work machine.

In one or some embodiments, the dimensional information may relate to dimensions of the attachment transverse to the direction of travel, such as transverse to the straight-ahead direction of travel, of the autonomous agricultural work machine.

In one or some embodiments, the dimensional information relating to the dimensions of the attachment may relate to the future coupled state planned for the autonomous agricultural work machine. In this regard, various dimensional information is contemplated, including any one, any combination, or all of: surrounding area of the autonomous agricultural work machine; a transverse surrounding area of the autonomous agricultural work machine; transverse dimensions of the attachment; dimension transverse to the direction of travel; dimensions of the attachment transverse to the direction of travel; or dimensions of the attachment relating to a future coupled state planned for the autonomous agricultural work machine.

In one or some embodiments, the planning portal is configured to automatically generate one or more notification signals responsive to the planning portal at least partly automatically determining that an impermissible selection of an attachment has been selected. In response to the planning portal at least partly automatically determining that an impermissible selection of an attachment has been selected, the planning portal may automatically transmit a notification of the impermissible selection to the farmer wired and/or wirelessly (e.g., via the means of communication). In this way, the automatic communication from the planning portal (sent via the means of communication) may notify the farmer of this impermissible selection of the attachment in accordance with the notification signal of the planning portal. This may ensure that the farmer does not accidentally select the wrong attachment, but may receive (such as always receive) safety-relevant feedback in such a case and may optimize his selection himself.

In one or some embodiments, the planning portal is configured to automatically generate a suggestion signal regarding a permissible and/or optimum attachment (e.g., an alternative or alternate attachment) in the event of an impermissible selection of an attachment and to transmit the permissible and/or optimum attachment to the farmer wired and/or wirelessly (e.g., via the means of communication). In this regard, in one or some embodiments, responsive to the planning portal at least partly automatically determining that an impermissible selection of an attachment has been selected, the planning portal may also at least partly (or entirely) automatically determine the permissible and/or optimum attachment and to automatically transmit one or both of: (i) the indication of the impermissible selection of an attachment; and/or (ii) the permissible and/or optimum attachment. Thus, the communication(s) from the planning portal may notify the farmer of the optimum attachment in accordance with the suggestion signal of the planning portal. In this way, the farmer may actively be supported in the correct selection of the optimum attachment and thus be relieved of work.

In one or some embodiments, the autonomous agricultural work machine may comprise a tractor.

In one or some embodiments, the autonomous agricultural work machine has a driver's cab for a driver.

In one or some embodiments, the dimensions of the attachment are wider than the width of the autonomous agricultural work machine. The attachment may therefore have a greater transverse width than the autonomous tractor.

In one or some embodiments, the planning portal may have a planning system with one or more servers, such as with a computer-based server, and a database, such as a computer-readable database in communication with the one or more servers. The information relating to the detectable surrounding area of the autonomous agricultural work machine and dimensional information relating to dimensions of the attachment may be saved in the database.

Furthermore, in one or some embodiments, the means of communication may be configured to communicatively connect (e.g., wired and/or wirelessly) with the planning portal in order to enable the farmer to select the attachment which will be coupled in planning to the autonomous agricultural work machine during an agricultural use. This means of communication may be designed as a smartphone, tablet, laptop and/or computer. Thus, in one or some embodiments, the farmer, via the means of communication, may input to the planning portal the selection of a respective attachment that will be coupled to a respective autonomous agricultural work machine during a respective agricultural use. The planning portal, responsive to receiving the input of the selection of a respective attachment that will be coupled to a respective autonomous agricultural work machine during a respective agricultural use, may automatically access information, such as saved to the database in order to determine: (1) whether the coupling of the respective attachment with the respective autonomous agricultural work machine is permissible or not; (2) whether to send one or more communications to request approval from the farmer for use of the respective attachment (if permissible) or for use of another attachment (if not permissible); and/or (3) performing one or more actions (e.g., sending one or more communications) so that one or more automatic actions may be performed (e.g., sending one or more communications to an electronic device, such as the respective autonomous agricultural work machine, in order for the respective autonomous agricultural work machine to operate at least partly autonomously or automatically).

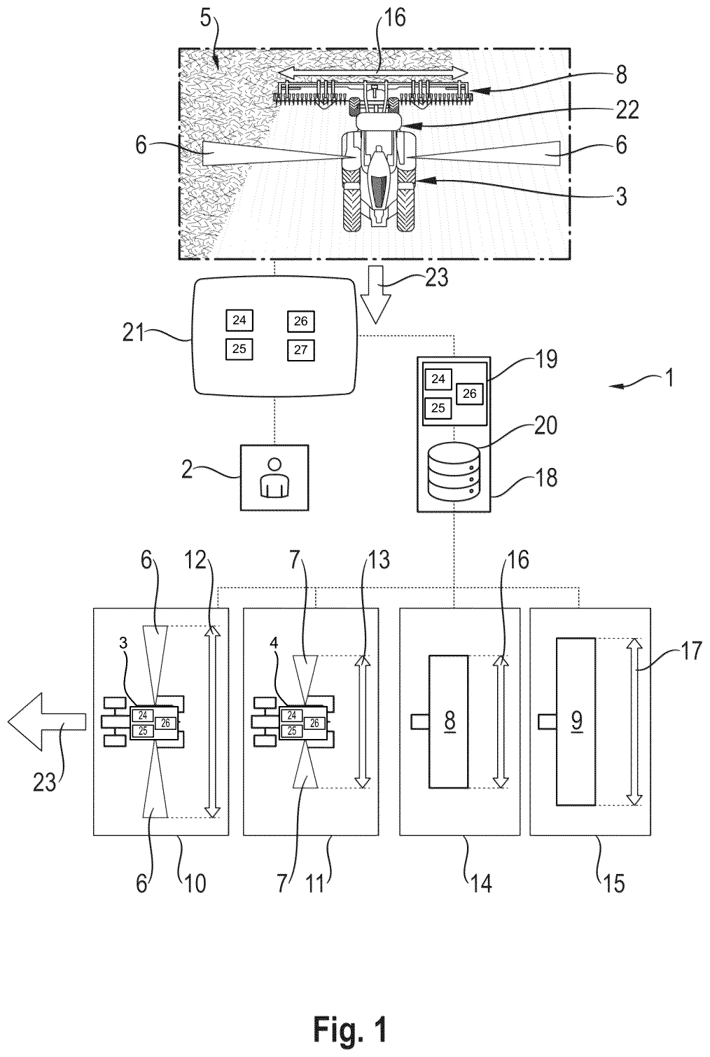

Referring to the FIGURES, FIG. 1 illustrates an example of a planning portal 1 for a farmer 2 configured to plan and/or initiate an agricultural operation of an autonomous agricultural work machine 3 on an agricultural field 5. The autonomous agricultural work machine 3, 4 may use a semi-autonomous operating mode and/or a fully autonomous operating mode during agricultural use. Autonomous agricultural work machines 3, 4 that have a semi-autonomous operation mode may include a driver's cab 22. Autonomous agricultural work machines 3, 4 that have a fully autonomous operating mode may be designed without a driver's cab 22. Autonomous agricultural work machines 3, 4 which have a semi-autonomous operating mode and a fully autonomous operating mode may have, among other things, a detachably couplable driver's cab 22.

The autonomous agricultural work machine 3 may comprise a tractor with a driver's cab 22, wherein no driver needs to be in this driver's cab 22 during the fully autonomous operating mode, whereas a driver may need to be in this driver's cab 22 during a semi-autonomous operating mode. This autonomous agricultural work machine 3 may be configured to detect a surrounding area 6 during agricultural use by means of a sensor-based system. Other types of autonomous agricultural work machines 3, 4 are contemplated, such as harvesters (e.g., combine harvester and/or forage harvester).

The planning of the agricultural use may comprise at least one planning step in which an attachment 8 is selected which will be coupled to the autonomous agricultural work machine 3 during the agricultural use. The planning portal 1 may comprise information 10, 11 regarding the detectable surrounding areas 6, 7 of a plurality of autonomous agricultural work machines 3, 4 as well as dimensional information 14, 15 regarding dimensions 16, 17 of a plurality of attachments 8, 9. For example, dimensional information 14 may correspond to attachment 8, with dimensions 16 correlated thereto. Alternatively, or in addition, dimensional information regarding the autonomous agricultural work machines 3, 4 may be stored and accessed by planning portal 1.

In one or some embodiments, the planning portal 1 is configured in such a way that, during planning, only the use of attachments 8, 9 is permitted which have dimensions 16, 17 such that the attachment 8, 9 is arranged or positioned completely within the detectable surrounding area 6, 7 during the state of the attachment 8, 9 being coupled to the autonomous agricultural work machine 3, 4. For this purpose, the planning portal 1 has a planning system 18 with a server 19 and a database 20, wherein the information 10, 11 relating to the detectable surrounding area 6, 7 of the autonomous agricultural work machines 3, 4 and dimensional information 14, 15 relating to dimensions 16, 17 of the attachment 8, 9 are saved in this database 20.

The information 10, 11 relating to the detectable surrounding area 6, 7 of the autonomous agricultural work machine 3, 4 may depend on the design of the work machine 3, 4 and/or properties of the sensor-based system. This may include a measured arrangement of the sensor-based system on the work machine 3, 4. In one or some embodiments, the dimensional information 14, 15 relating to the dimensions 16, 17 of the attachments 8, 9 may be measured dimensional values of the respective attachment 8, 9. For example, the dimensional information 14, 15 relating to the dimensions 16, 17 of the attachments 8, 9 may be predetermined values based on the model and/or type of attachments 8, 9.

In one or some embodiments, the information 10, 11 relating to the detectable surrounding area 6, 7 of the autonomous agricultural work machines 3, 4 may relate to dimensions 12, 13 transverse to the direction of travel 23 of the autonomous agricultural work machine 3, 4. The dimension information 14, 15 may relate to dimensions 16, 17 of the respective attachment 8, 9 transverse to the direction of travel 23 of the autonomous agricultural work machine 3, 4. For example, the autonomous agricultural work machine 3 may be used with both the attachment 8 and the attachment 9, whereas the work machine 4 may only use the attachment 8 since the dimension 17 of the attachment 9 is larger than the detectable surrounding area 7 of the autonomous agricultural work machines 4. In this regard, the planning portal 1 may be configured to automatically any dynamically determine whether a respective attachment may be used (e.g., whether the transverse dimension of the respective attachment is less than or equal to the transverse dimension of the respective surrounding area (e.g., surrounding area 6 or 7).

In one or some embodiments, the planning portal 1 may be in communication with a communication device 21 with which the farmer 2, while planning, selects the attachment 8 or 9, which will be coupled to the autonomous agricultural work machine 3 during agricultural use. The communication device 21 may be designed as a smartphone, tablet, laptop and/or computer. In this regard, communication device 21 may include a processor 24, a memory 25 and a communication interface 26 configured to communicate wired and/or wirelessly with external devices, such as planning portal 1, discussed further below. Further, the communication device 21 may comprise a display 27, such as a touchscreen display, or other type of input/output device. In one or some embodiments, Responsive to receipt of the selection of the respective attachment from the farmer, the planning portal 1 may determine whether the respective attachment is permitted. If so, the planning portal 1 may send one or more communications to the communication device 21 indicating that the selection is permissible. Alternatively, the planning portal 1 may automatically implement use of the respective attachment responsive to the selection and the determination by the planning portal 1 that the selection is permissible. Alternatively, responsive to receipt of the selection of the respective attachment from the farmer, the planning portal 1 may determine whether the respective attachment is not permitted (e.g., the dimensions of the respective attachment are too large). In such an instance, the planning portal 1, in communicating with the farmer 2, may send one or more communications to the communication device 21 for output on display 27. The one or more communications may comprise indications that: (i) the selection of the respective attachment is not permissible; and/or (ii) recommended alternative attachment(s) for selection (e.g., a single alternative attachment that is permissible or a list of alternative attachments that are permissible); and/or (iii) a request for approval by the farmer to use the alternative attachment(s) (e.g., a single communication is displayed on display 27 indicating that the selection of the respective attachment is not permissible and/or the recommended alternative attachment (e.g., an optimum attachment) for selection and/or the request for approval by the farmer to use the alternative attachment). Responsive to receiving the one or more communications, the farmer 2 may approve or reject via the display 27 the recommended alternative attachment(s). Responsive to receiving input from the farmer 2 indicating approval or rejection of recommended alternative attachment(s), the communication device 21 may send the indication of approval or rejection to the planning portal 1. Responsive to the planning portal 1 receiving approval, the planning portal 1 may take one or more at least partly automatic actions (e.g., sending one or more communication to the autonomous agricultural work machine 3, 4 in order for the autonomous agricultural work machine 3, 4 to operate at least partly autonomously or automatically). Responsive to the planning portal 1 receiving a rejection of the recommended alternative attachment, the planning portal 1 may select yet a different attachment (e.g., different from the alternative attachment or the optimum attachment). In turn, the planning portal 1 may send the yet different attachment to the communication device 21 for approval again by the farmer 2. This process may continue until the farmer 2 approves a permissible attachment.

The planning portal 1 may be configured to generate a notification signal in the event of an impermissible selection of an attachment 8, 9 and to transmit it to the communication device 21 of the farmer 2. For example, responsive to input by the farmer 2 of a selection of a respective attachment (e.g., attachment 8 or attachment 9), the planning portal 1 may automatically determine whether the selection of the respective attachment is permissible. Specifically, responsive to the planning portal 1 automatically determining that the respective attachment that was selected by the farmer 2 is permissible (e.g., the dimensions 16, 17 of the respective attachment 8, 9 is less than or equal to the respective surrounding area (e.g., surrounding area 6 or 7)), in one or some embodiments, the planning portal 1 may automatically send a communication to the communication device 21 that the selection of the respective attachment is permissible. Alternatively, responsive to the planning portal 1 automatically determining that the respective attachment that was selected by the farmer 2 is permissible, the planning portal 1 may send no communication to the communication device 21 that the selection of the respective attachment is permissible. Still alternatively, responsive to the planning portal 1 automatically determining that the respective attachment that was selected by the farmer 2 is impermissible (e.g., the dimensions 16, 17 of the respective attachment 8, 9 is greater than the respective surrounding area (e.g., surrounding area 6 or 7)), in one or some embodiments, the planning portal 1 may automatically send a communication to the communication device 21 that the selection of the respective attachment is permissible. In one or some embodiments, with or in conjunction with this communication, the planning portal 1 may indicate one or both of: (1) a reason as to why the selection of the respective attachment is impermissible; and/or (2) a suggestion for an alternative attachment that is considered permissible. In this regard, the communication device 21 may automatically notify the farmer of this impermissible selection of the attachment 8, 9 in accordance with the notification signal of the planning portal 1. Thus, the planning portal 1 may automatically notify the farmer 2 of errors in selection. For example, responsive to the planning portal 1 automatically determining that the farmer 2 has selected the autonomous agricultural work machine 4 and, due to a high workload, has accidentally selected the attachment 9, the planning portal 1 may automatically transmit the notification signal to the farmer 2 to indicate early and reliably that this attachment 9 must not be used under any circumstances.

Alternatively or additionally, the planning portal 1 may be automatically configured to generate a suggestion signal regarding a permissible and/or optimum attachment 8, 9 in the event of an impermissible selection of an attachment 8, 9 and to automatically transmit permissible and/or optimum attachment 8, 9 to the communication device 21 of the farmer 2. Thus, the planning portal 1, via the communication device 21, may automatically notify the farmer 2 of the optimum attachment 8 and/or 9 in accordance with the suggestion signal of the planning portal 1. Responsive to the planning portal 1 automatically determining that the farmer 2 has selected the autonomous agricultural work machine 4 and, due to a high workload, has accidentally selected the attachment 9, the planning portal 1 may automatically transmit the information signal to indicate early and reliably that a different attachment (e.g., the attachment 8) should be used.

In one or some embodiments, the initiation and/or performing step may be at least partly automatically performed in order to at least partly automatically perform the agricultural job. For example, initiation and/or performing of an agricultural use in order to perform the agricultural job may be based on the automatic planning of the planning portal 1 and may comprise one or more initiation signals that are automatically transmitted to the autonomous agricultural work machine 3, 4. During the agricultural use in order to perform the agricultural job, the autonomous agricultural work machine 3, 4 may at least partly (or entirely) automatically use these one or more initiation signals in addition to other signals, such as sensor signals, to automatically control and/or regulate the work machine 3, 4 and/or the attachment 8, 9 in order to automatically perform the agricultural job. In this regard, the planning portal 1, with its automatic planning and checking as to whether the selection of the configuration (e.g., the combination of the respective autonomous agricultural work machine 3, 4 and the respective attachment 8, 9) is permissible, may automatically send the one or more initiation signals. Responsive to the respective autonomous agricultural work machine 3, 4 receiving the one or more initiation signals, the respective autonomous agricultural work machine 3, 4 may at least partly (or entirely) automatically perform the agricultural job. As one example, responsive to automatically receiving the one or more initiation signals, the respective autonomous agricultural work machine 3, 4 may automatically output (e.g., on a touchscreen) the indication that the selection of the configuration is permissible and may request the farmer 2 input whether to proceed. Responsive to input from the farmer 2 inputting via the touchscreen to proceed, the respective autonomous agricultural work machine 3, 4 may automatically proceed to at least partially (or entirely) automatically perform the agricultural job. As another example, responsive to automatically receiving the one or more initiation signals, the respective autonomous agricultural work machine 3, 4 may automatically proceed to at least partially (or entirely) automatically perform the agricultural job (without any input from the farmer 2).

In this way, the planning portal 1 may ensures that no attachments 8, 9 are used with the autonomous agricultural work machine 3, 4 that would be arranged or positioned outside the detectable surrounding area 6, 7 and may therefore cause a danger (e.g., endanger people) during agricultural use in at least partly automatically performing the agricultural job.

As discussed above, the planning portal 1 may be configured to at least partly automatically perform one or more operations, such as planning and/or initiation. In this regard, in one or some embodiments, the planning portal 1 may comprise a planning system 18 that includes server 19. Server 19 may include at least one processor 24, at least one memory 25, and at least one communication interface 26. The at least one processor 24 and at least one memory 25 may be in communication (e.g., wired and/or wirelessly) with one another. In one or some embodiments, the processor 24 may comprise a microprocessor, controller, PLA, or the like. Similarly, the memory 25 may comprise any type of storage device (e.g., any type of memory). Though the processor 24 and the memory 25 are depicted as separate elements, they may be part of a single machine, which includes a microprocessor (or other type of controller) and a memory. Alternatively, the processor 24 may rely on the memory 25 for all of its memory needs. Still alternatively, the processor 24 may rely on the database 20 for some or all of its memory needs. The memory 25 may comprise a tangible computer-readable medium that include software that, when executed by the processor 24 is configured to perform any one, any combination, or all of the functionality described herein, such as the functionality of the planning portal 1, including one or both of automatically performing the planning and/or initiation. Further, the communication interface 26 may be configured to communicate (e.g., wired and/or wirelessly) with one or more external electronic devices. For example, planning portal 1 may be configured to communicate with any one, any combination, or all of: communication device 21; server 19; or autonomous agricultural work machine 3, 4.

Similarly, the autonomous agricultural work machines 3, 4 may have computing functionality in order to perform at least autonomously or automatically (the terms autonomous and automatic may be considered interchangeable). Examples of autonomous agricultural work machines 3, 4 are disclosed in: US Patent Application Publication No. 2014/0324272 A1; US Patent Application Publication No. 2023/0350426 A1; US Patent Application Publication No. 2023/0350407 A1; US Patent Application Publication No. 2023/0350423 A1; US Patent Application Publication No. 2023/0350409 A1; US Patent Application Publication No. 2023/0345856 A1; or US Patent Application Publication No. 2024/0065155 A1, each of which are incorporated by reference herein in their entirety. In one or some embodiments, the autonomous agricultural work machines 3, 4 may include a GPS receiver (or other type of location determining device) in order to determine the location of the autonomous agricultural work machines 3, 4. Further, the autonomous agricultural work machines 3, 4 may include a driver assistance system in order to at least partly (or entirely) automatically the driving of the autonomous agricultural work machines 3, 4 and may further include one or more automatically operating working units configured to automatically perform one or more operations by the autonomous agricultural work machines 3, 4 (e.g., operating the attachments 8, 9 and/or operating devices on the autonomous agricultural work machines 3, 4, or the like). In this regard, in one or some embodiments, the planning portal 1 may be configured to perform any one, any combination, or all of: (1) automatically determine whether the respective attachment 8, 9 is permissible to use; automatically determine the route that the autonomous agricultural work machine 3, 4 is to take; automatically determine the operations to perform along the route (including the automatic operations of the attachments 8, 9 and/or the automatic operations of the operating devices resident on the autonomous agricultural work machines 3, 4); or automatically transmitting to the attachments 8, 9 and/or operating devices on the autonomous agricultural work machine 3, 4 any one, any combination, or all of whether the attachment 8, 9 is permissible, the route, or the automatic operations to perform along the route. An example of route planning is disclosed in U.S. patent application Ser. No. ______ (attorney docket no. 15191-24024A (P05791/8), which is incorporated by reference herein in its entirety. Thus, responsive to the planning portal 1 receiving input from the farmer 2, the planning portal 1 may automatically transmit one or more items of information to the autonomous agricultural work machine 3, 4. Responsive to the autonomous agricultural work machine 3, 4 receiving the one or more items of information, the autonomous agricultural work machine 3, 4 may perform at least partly (or entirely) automatic operations.

The processor 24 and the memory 25 are merely one example of a computational configuration for the server 19 or the autonomous agricultural work machine 3, 4. Other types of computational configurations are contemplated. For example, all or parts of the implementations may be circuitry that includes a type of controller, including an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

Further, it is intended that the foregoing detailed description be understood as an illustration of selected forms that the invention may take and not as a definition of the invention. It is only the following claims, including all equivalents, that are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting physical properties model may be downloaded or saved to computer storage.

### LIST OF REFERENCE NUMBERS

1 Planning portal
2 Farmer
3 Autonomous agricultural work machine
4 Other autonomous agricultural work machine
5 Agricultural field
6 Surrounding area
7 Surrounding area of the other agricultural work machine
8 Attachment
9 Other attachment
10 Information on the work machine
11 Information on the other work machine
12 Dimensions of the detectable surrounding area of the work machine
13 Dimensions of the detectable surrounding area of the other work machine
14 Dimensional information of the attachment
15 Dimensional information of the other attachment
16 Dimension of the attachment
17 Dimension of the other attachment
18 Planning system
19 Server
20 Database
21 Communication device
22 Driver's cab
23 Direction of travel, in particular straight-ahead direction of travel
24 Processor
25 Memory
26 Communication interface
27 Display

1. A planning portal for a farmer to plan and initiate an agricultural use of an autonomous agricultural work machine on an agricultural field, wherein the autonomous agricultural work machine is configured to detect a surrounding area during the agricultural use using a sensor-based system, the planning portal comprising:
a database configured to store information relating to the detectable surrounding area of the autonomous agricultural work machine and dimensional information relating to dimensions of one or more attachments;
a communication device configured to communicate with at least one external electronic device; and
at least one processor in communication with the database and the communication device, the at least one processor configured to:
responsive to a selection of a respective attachment for coupling with the autonomous agricultural work machine:
automatically access the information relating to the detectable surrounding area of the autonomous agricultural work machine and dimensional information relating to dimensions of the attachment that is selected;
automatically determine whether the respective attachment that is selected, when coupled to the autonomous agricultural work machine, is positioned within the detectable surrounding area of the autonomous agricultural work machine in order to determine whether use of the respective attachment with the autonomous agricultural work machine is permitted; and
responsive to determining that the use of the respective attachment with the autonomous agricultural work machine is permitted:
automatically transmit at least one communication in order for the autonomous agricultural work machine when coupled to the respective attachment to perform at least partly automatic operations for the agricultural use.

2. The planning portal of claim 1, wherein the at least one processor, responsive to determining that the agricultural use of the respective attachment with the autonomous agricultural work machine is not permitted, is further configured to:
automatically send one or more communications to a farmer of the autonomous agricultural work machine in order to indicate the selection of the respective attachment for coupling with the autonomous agricultural work machine is not permitted.

3. The planning portal of claim 2, wherein the at least one processor, responsive to determining that the use of the respective attachment with the autonomous agricultural work machine is not permitted, is further configured to:
automatically determine an alternate attachment different from the respective attachment that was selected for the agricultural use; and
automatically transmit the one or more communications for receipt by the farmer of the autonomous agricultural work machine in order for the autonomous agricultural work machine to be coupled to the alternative attachment in performing at least partly automatic operations for the agricultural use.

4. The planning portal of claim 3, wherein the at least one processor is configured to automatically determine an alternate attachment different from the respective attachment that was selected for the agricultural use by determining an optimum attachment responsive to the selection of the respective attachment is not permitted; and
wherein the at least one processor is configured to automatically transmit, in the one or more communications, the optimum attachment.

5. The planning portal of claim 4, wherein the at least one processor is configured to automatically transmit, in the one or more communications, the optimum attachment with a request for approval by the farmer to use the optimum attachment;
responsive to receiving approval from the farmer to use the optimum attachment, the at least one processor is configured to send at least one communication in order to at least partly automatically use the optimum attachment for the agricultural use; and
responsive to receiving a rejection from the farmer to use the optimum attachment, the at least one processor is configured to determine a different attachment to use with the autonomous agricultural work machine.

6. The planning portal of claim 4, wherein the database is further configured to store the information relating to the detectable surrounding areas of a plurality of autonomous agricultural work machines and dimensional information relating to dimensions of a plurality of attachments.

7. The planning portal of claim 6, wherein each respective autonomous agricultural work machine of the plurality of autonomous agricultural work machines has respective detectable surrounding area correlated to the respective autonomous agricultural work machine;
wherein each respective attachment of the plurality of attachments has respective dimensional information relating to the dimensions correlated to the respective attachment;
wherein the at least one processor is configured to automatically access the information relating to the detectable surrounding area of the autonomous agricultural work machine and the dimensional information relating to the dimensions of the respective attachment that is selected by:
access the respective detectable surrounding area correlated to the respective autonomous agricultural work machine selected to perform the agricultural use; and
access the respective dimensional information relating to the dimensions to the respective attachment.

8. The planning portal of claim 7, wherein the respective attachment is selected by the farmer for coupling with the autonomous agricultural work machine;
wherein the at least one processor is configured to, responsive to determining that the use of the respective attachment selected by the farmer for coupling with the autonomous agricultural work machine is not permitted, automatically determine the alternate attachment different from the respective attachment that was selected for the agricultural by:
selecting a different attachment from the plurality of attachments;
automatically determining whether the different attachment that is selected, when coupled to the autonomous agricultural work machine, is positioned within the detectable surrounding area of the autonomous agricultural work machine in order to determine whether use of the different attachment with the autonomous agricultural work machine is permitted; and
responsive to determining that the different attachment is permitted, automatically transmit the at least one communication in order for the autonomous agricultural work machine when coupled to the different attachment to perform at least partly automatic operations for the agricultural use.

9. The planning portal of claim 1, wherein the at least one processor is configured to receive the selection of the respective attachment for coupling with the autonomous agricultural work machine from the farmer via an electronic device; and
wherein the selection received from the electronic device is selected by the farmer from a plurality of attachments displayed on a screen of the electronic device.

10. The planning portal of claim 1, wherein the information relating to the detectable surrounding area relates to a transverse surrounding area of the autonomous agricultural work machine.

11. The planning portal of claim 10, wherein the dimensional information relates to transverse dimensions of the respective attachment; and
wherein the at least one processor is configured to automatically determine whether use of the respective attachment with the autonomous agricultural work machine is permitted by determining whether the transverse dimensions of the respective attachment is equal to or within the transverse surrounding area of the autonomous agricultural work machine.

12. The planning portal of claim 1, wherein the information relating to the detectable surrounding area of the autonomous agricultural work machine relates to a dimension transverse to a direction of travel of the autonomous agricultural work machine.

13. The planning portal of claim 12, wherein the dimensional information relates to dimensions of the one or more attachments transverse to the direction of travel of the autonomous agricultural work machine.

14. The planning portal of claim 1, wherein the dimensional information relating to the dimensions of the one or more attachments relates to a future planned coupling state of a respective attachment with the autonomous agricultural work machine.

15. The planning portal of claim 1, wherein the autonomous agricultural work machine comprises a tractor.

16. The planning portal of claim 1, wherein the autonomous agricultural work machine includes a driver's cab.

17. The planning portal of claim 1, wherein the dimension of the respective attachment is wider than a width of the autonomous agricultural work machine; and
wherein the at least one processor is configured to determine that the respective attachment is not permitted by comparing the dimension of the respective attachment with the width of the autonomous agricultural work machine.

18. The planning portal of claim 1, wherein the at least one processor comprises at least one server.

19. A communication device configured to communicate with a planning portal, the communication device comprising:
a display;
at least one communication interface configured to communicate with the planning portal; and
at least one processor in communication with the display and the communication interface and configured to:
input, via the display, a selection for a respective attachment for use with an autonomous agricultural work machine;
transmit, via the at least one communication interface, the selection for a respective attachment;
receive an indication of whether the selection is at least one of permissible or not permissible for use with the autonomous agricultural work machine, the indication being generated by the planning portal by:
responsive to the planning portal receiving the selection of the respective attachment for coupling with the autonomous agricultural work machine:
automatically access information from a database, the database configured to store the information relating to a detectable surrounding area of the autonomous agricultural work machine and dimensional information relating to dimensions of one or more attachments, the information relating to the detectable surrounding area of the autonomous agricultural work machine and dimensional information relating to dimensions of the attachment that is selected;
automatically determine whether the respective attachment that is selected, when coupled to the autonomous agricultural work machine, is positioned within the detectable surrounding area of the autonomous agricultural work machine in order to determine whether use of the respective attachment with the autonomous agricultural work machine is permitted; and
send the indication of whether the selection is at least one of permissible or not permissible for use with the autonomous agricultural work machine.
